(19) United States
(12) Patent Application Publication
(10) Pub. No.: US 2015/0316799 A1
(43) Pub. Date: Nov. 5, 2015

(54) DISPLAY PANEL STRUCTURE AND MANUFACTURING METHOD THEREOF

(71) Applicant: HANNSTAR DISPLAY CORPORATION, Taipei City (TW)

(72) Inventors: Chun-Chiang CHEN, Taipei City (TW); Chuan-Tzong KUO, Taipei City (TW)

(21) Appl. No.: 14/699,549

(22) Filed: Apr. 29, 2015

(30) Foreign Application Priority Data
Apr. 30, 2014 (CN) 201410182129.9
Apr. 30, 2014 (CN) 201410183095.5

(51) Int. Cl. G02F 1/1339; G02F 1/1343

(52) U.S. Cl. CPC G02F 1/1339; G02F 1/13439

(57) ABSTRACT

A manufacturing method of a display panel structure comprises steps of: disposing a plurality of first sealants around a plurality of LCD units on a first substrate, respectively, to form at least an LCD array; forming at least a second sealant on the first substrate, so that the second sealant is disposed on the outside of the LCD array in a multi-segment manner; and attaching a second substrate and the first substrate to each other, so that the second sealant connects the first substrate and the second substrate. Thereby, the problems of the substrate peeling and fragment occurring in the process of the dorsal plating forming a conducting layer can be improved, and besides, the internal strike effect of the liquid crystal can be restrained, so as to enhance the technical yield.

### CROSS REFERENCE TO RELATED APPLICATIONS

This Non-provisional application claims priority under 35 U.S.C. §119(a) on Patent Application No(s). 201410183095.5 and 201410182129.9 filed in People's Republic of China on Apr. 30, 2014, the entire contents of which are hereby incorporated by reference.

### BACKGROUND OF THE INVENTION

1. Field of Invention

This invention relates to a display panel structure and a manufacturing method thereof.

2. Related Art

Liquid crystal display (LCD) apparatuses, having advantages such as low power consumption, less heat, light weight and non-radiation, are widely applied to various electronic products and gradually take the place of cathode ray tube (CRT) display apparatuses.

In general, the liquid crystal display apparatus mainly comprises an LCD panel, a driving module and a backlight module. The LCD panel mainly includes a thin film transistor (TFT) substrate, a color filter (CF) substrate and a liquid crystal layer between the two substrates.

In the conventional manufacturing process of an LCD panel, a plurality of sealants will be disposed on the TFT substrate, and the region within each of the sealants will be filled with liquid crystal, and then a display panel structure including a plurality of LCD units can be obtained after the TFT substrate and the CF substrate are attached to each other under vacuum and the sealants are cured. Then, an additional sealant will be disposed on the edges of the panel structure, and then the processes of the substrate thinning, dorsal plating to form a transparent conducting layer and slicing are implemented to obtain a plurality of LCD panels.

However, during the process of the dorsal plating to form a transparent conducting layer, a transparent conducting layer needs to be formed on the outer surface of the CF substrate under vacuum, and therefore the problems of the substrate peeling and fragment will be caused. Moreover, since the sealant is not completely cured when the TFT substrate and the CF substrate are attached to each other under vacuum, the internal strike effect where the liquid crystal molecules strike the sealant (the condition will become more serious with the less panel size) will occur after the attached substrates return to the atmosphere environment. This will result in the LC leakage and the yield will be thus reduced.

### SUMMARY OF THE INVENTION

An objective of this invention is to provide a display panel structure and manufacturing method thereof whereby the problems of the substrate peeling and fragment occurring in the process of the dorsal plating to form a transparent conducting layer can be improved, and besides, the internal strike effect can be restrained, so as to enhance the technical yield.

To achieve the above objective, a manufacturing method of a display panel structure according to the invention comprises steps of: disposing a plurality of first sealants around a plurality of liquid crystal display (LCD) units on a first substrate, respectively, to form at least an LCD array; forming at least a second sealant on the first substrate, so that the second sealant is disposed on the outside of the LCD array in a multi-segment manner; and attaching a second substrate and the first substrate to each other, so that the second sealant connects the first substrate and the second substrate.

In one embodiment, in the step of forming the at least an LCD array, the liquid crystal are filled into the regions bounded by the first sealants by the one drop filling (ODF) process.

In one embodiment, in the step of forming the at least a second sealant, the second sealant is disposed between the LCD arrays.

In one embodiment, in the step of forming the at least a second sealant, the second sealant is disposed between the LCD array and the edges of the first substrate.

In one embodiment, in the step of forming the at least a second sealant, the second sealants are arranged into an array formed by columns and row.

In one embodiment, in the step of forming the at least a second sealant, the two adjacent second sealants along the column direction or row direction form an interval region.

In one embodiment, the manufacturing method further comprises a step of: forming a third sealant sealing the edges of the first substrate and second substrate.

In one embodiment, the manufacturing method further comprises a step of: forming at least a transparent conducting layer on an outer surface of the first substrate or second substrate.

In one embodiment, in the step of forming the at least a transparent conducting layer, the manufacturing method further comprises steps of: forming the amorphous transparent conducting layer on a surface of the first substrate or second substrate; patterning the amorphous transparent conducting layer by high energy pulse to make the patterned amorphous transparent conducting layer transformed into the patterned polycrystalline transparent conducting layer; and removing the non-patterned amorphous transparent conducting layer by etching.

To achieve the above objective, a display panel structure according to the invention comprises a first substrate, a second substrate, a plurality of LCD arrays, a plurality of first sealants and a plurality of second sealants. The second substrate is disposed corresponding to the first substrate. The LCD arrays disposed between the first substrate and the second substrate and in an array and disposed separately. At least a cross-like interval region is formed between the LCD arrays and each of the LCD arrays includes a plurality of LCD units. The first sealants are disposed around the LCD units, respectively. The second sealants are disposed in the cross-like interval region.

In one embodiment, each of the second sealants disposed between the LCD arrays and the edges of the first substrate is a double-layer structure and at least some of the second sealants are the closed-type ones.

In one embodiment, the closed-type second sealant disposed on the upper or lower side of the first substrate is not connected with the closed-type second sealant disposed on the left or right side of the first substrate, and the adjacent closed-type second sealants disposed between the left or right edges of the LCD array and first substrate are not connected with each other.

In one embodiment, the closed-type second sealants disposed in the cross-like interval region are connected with each other and formed into a closed cross shape, and also formed into a shape like “#” in the middle portion.

In one embodiment, the second sealants disposed in the cross-like interval region are connected with each other and formed into a closed cross shape, and also formed into a shape like “#” in the middle portion.

In one embodiment, the second sealants, which are disposed in the cross-like interval region, are double-layer and multi-segment structures and formed into a cross shape.

In one embodiment, the second sealants, which are disposed in the cross-like interval region, are double-layer and multi-segment structures and formed into a cross shape, and are connected with the second sealants disposed between the LCD arrays and the edges of the first substrate.

In one embodiment, the second sealants, which are disposed in the cross-like interval region, are double-layer and multi-segment structures and formed into a cross shape, and are not connected with the second sealants disposed between the LCD arrays and the edges of the first substrate.

In one embodiment, the adjacent closed-type second sealants disposed between the upper or lower edges of the LCD arrays and first substrate are not connected to each other.

In one embodiment, the second sealants disposed in the cross-like interval region are disposed between the LCD arrays and are disposed separately to form the cross-like interval region.

In one embodiment, the second sealants disposed in the cross-like interval region are connected to each other and formed into a cross shape.

In one embodiment, the second sealant is disposed between the LCD array and the edges of the first substrate and without openings.

In one embodiment, the second sealants disposed in the cross-like interval region are connected to each other in a multi-segment manner and formed into a cross shape.

In one embodiment, the second sealants are disposed on the outside of the LCD units and have at least an opening.

In one embodiment, the width of the opening is greater than 3 cm.

In one embodiment, the display panel structure further comprises at least a transparent conducting layer disposed on an outer surface of the first substrate or second substrate.

In one embodiment, the transparent conducting layer is a polycrystalline patterned transparent conducting layer.

In one embodiment, the display panel structure further includes a third sealant sealing the edges of the first substrate and second substrate.

As mentioned above, the manufacturing method of the display panel structure of this invention includes the steps of: disposing a plurality of first sealants around a plurality of LCD units on a first substrate, respectively, to form at least an LCD array; forming at least a second sealant on the first substrate, so that the second sealant is disposed on the outside of the LCD array in a multi-segment manner; and attaching the second substrate and the first substrate to each other, so that the second sealant connects the first substrate and the second substrate. Moreover, in the display panel structure of this invention, the LCD arrays are disposed separately, at least a cross-like interval region is formed between the LCD arrays, and the second sealants are disposed in the cross-like interval region and disposed on the outside of the LCD arrays in a multi-segment manner. Thereby, in comparison with the conventional art, the problems of the substrate peeling and fragment occurring during the process of forming the transparent conducting layer for the display panel structure under vacuum can be improved, and besides, the internal strike effect of the liquid crystal occurring when the first substrate and the second substrate are attached to each other under vacuum and then return to the atmosphere environment can be restrained, so as to enhance the technical yield.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic flowchart of a manufacturing method of a display panel structure of an embodiment of the invention;

FIG. 1B is a schematic flowchart of a manufacturing method of a display panel structure of another embodiment of the invention;

FIGS. 2A and 2B are schematic diagrams showing the processes of the manufacturing method of the display panel structure;

FIGS. 2C and 2D are schematic diagrams showing the processes of the manufacturing method of the display panel structure of another embodiment of the invention;

FIGS. 3A and 3B are schematic diagrams showing the processes of the manufacturing method of the display panel structure of another embodiment of the invention; and

FIGS. 4A to 4G are schematic top-view diagrams of the display panel structures of different embodiments of the invention.

### DETAILED DESCRIPTION OF THE INVENTION

The present invention will be apparent from the following detailed description, which proceeds with reference to the accompanying drawings, wherein the same references relate to the same elements.

In order to clearly show the features of this invention, each of the first sealant and the second sealant is shown by a dotted line in the following top-view diagrams, but in fact, each of them is a layer structure with a certain width.

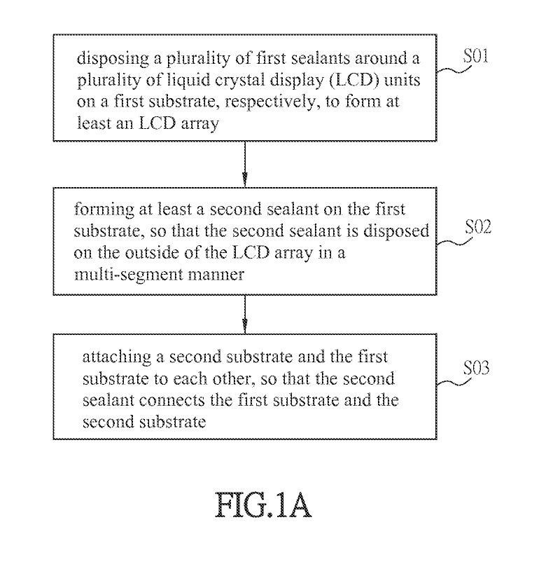

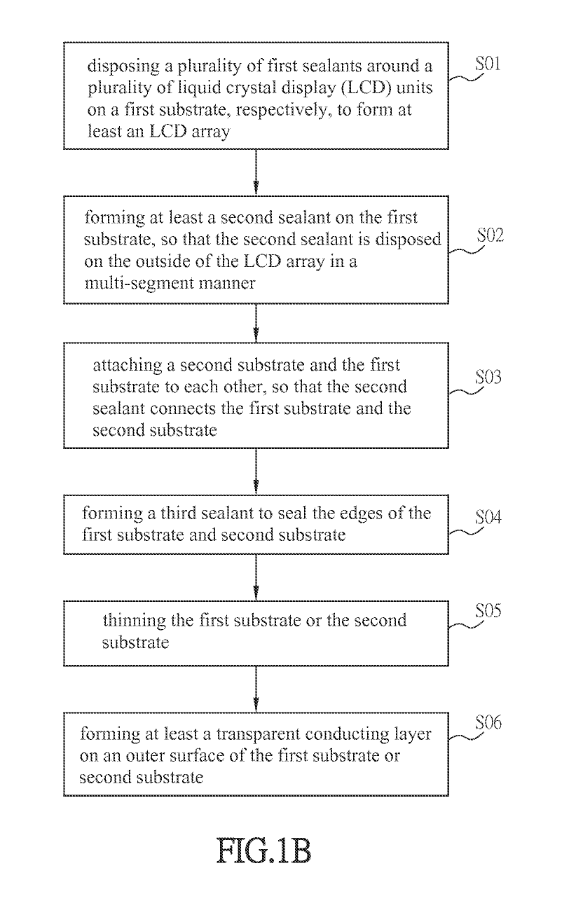

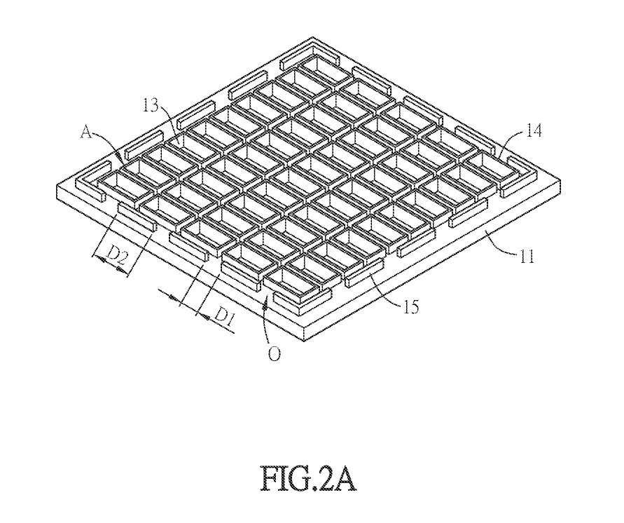

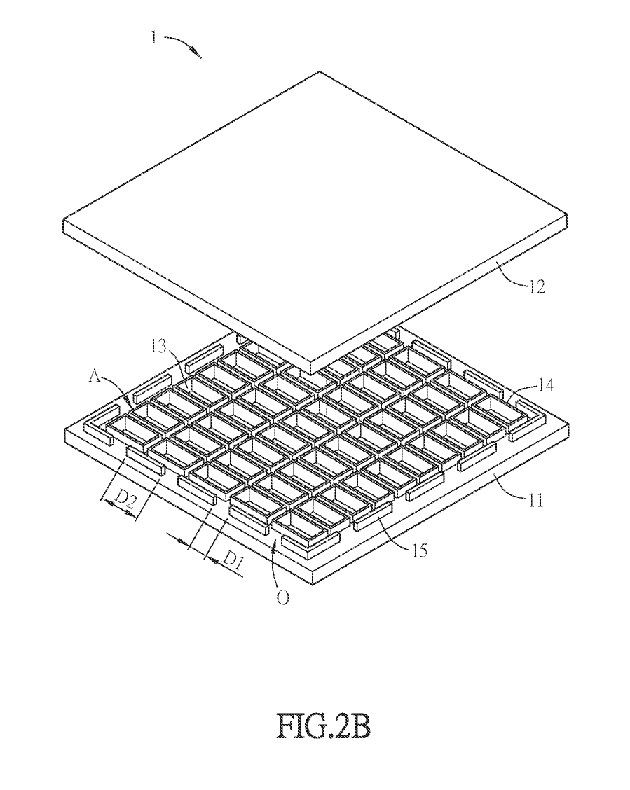

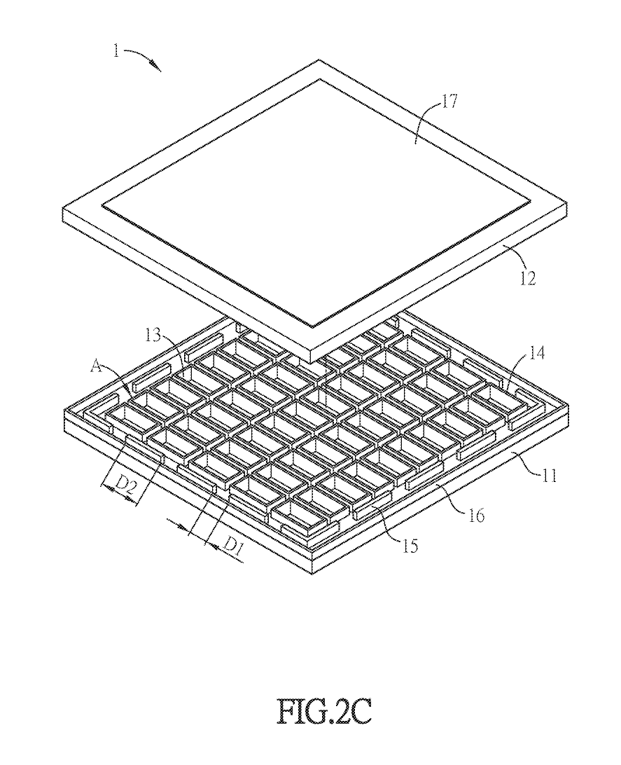

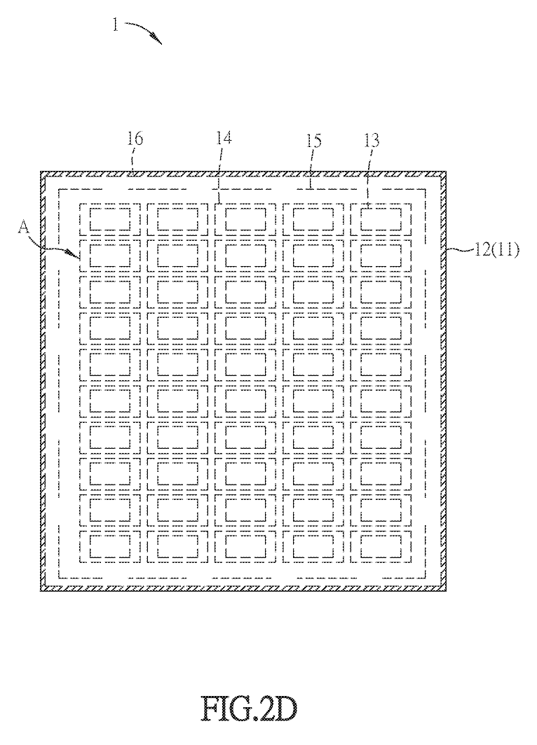

Referring to FIGS. 1A, 2A and 2B, FIG. 1A is a schematic flowchart of a manufacturing method of a display panel structure of an embodiment of the invention, and FIGS. 2A and 2B are schematic diagrams showing the processes of the manufacturing method of the display panel structure.

As shown in FIG. 1A, the manufacturing method of the display panel structure includes the steps S01˜S03.

At first, as shown in FIG. 2A, the step S01 is to dispose a plurality of first sealants 14 around a plurality of liquid crystal display (LCD) units 13 on a first substrate 11, respectively, to form at least an LCD array A. The first substrate 11 can be made by transparent material, such as glass, quartz or the like, plastic material, rubber, fiberglass or other polymer materials. Or, the first substrate 11 can be made by opaque material and can be a metal-fiberglass composite plate, a metal-ceramic composite plate, a printed circuit board or other types. The LCD units 13 of this embodiment are disposed in a matrix (two-dimensional array) formed by columns (the direction Y) and rows (the direction X). Each of the LCD units 13 can be a fringe field switching (FFS) LCD unit or an in-plane switch (IPS) LCD unit (for FFS and IPS, a covering electrode disposed on the substrate is required for preventing the static electricity from affecting the display quality), but this invention is not limited thereto. The first sealant 14 can be a thermo-curing adhesive, a photo curing-adhesive or their combination. Herein for example, the first sealant 14 is a photo-curing adhesive (such as UV adhesive), and is, for example but not limited to, formed on the first substrate 11 in a coating manner under atmosphere environment. Each of the first sealants 14 is disposed in an annular manner to form a containing space, and therefore the liquid crystal molecules can be filled into the containing space of the first sealant 14 to form an LCD unit 13. The liquid crystal molecules are, for example but not limited to, filled in the regions bounded by the first sealants 14 by the one drop filling (ODF) process, so that the first sealants 14 are disposed around the LCD units 13, respectively.

Then, the step S02 is to form at least a second sealant 15 on the first substrate 11, so that the second sealant 15 is disposed on the outside of the LCD array A in a multi-segment manner. Herein, a single second sealant 15 is illustrated as an example. The second sealant 15 can be a thermo-curing adhesive, a photo-curing adhesive or their combination. Herein for example, the second sealant 15 is the combination of a thermo-curing adhesive and a photo-curing adhesive. For example, the second sealant 15 can be formed on the first substrate 11 by coating under atmosphere environment, and is disposed on the outside of the LCD units 13 of the LCD array A in a multi-segment manner. In other words, the second sealant 15 includes a plurality of segments (an opening O exists between one segment and another segment), and these segments are disposed on the outside of the LCD units 13 which are formed in an array. As shown in FIG. 2A, the distance D1 between the two segments of the second sealant 15 can be greater than 3 cm (i.e. the opening O between the two segments is at least 3 cm). Besides, the length D2 of each segment of the second sealant 15 can be less than or equal to 30 cm (i.e. D2≦30 cm). However, in other embodiments, the length D2 of each segment of the second sealant 15 can be greater than 30 cm.

Then, as shown in FIG. 2B, the step S03 is to attach a second substrate 12 and the first substrate 11 to each other, so that the second sealant 15 connects the first substrate 11 and the second substrate 12. The second substrate 12 also can be made by transparent material, such as glass, quartz or the like, plastic material, rubber, fiberglass or other polymer materials. Or, the second substrate 12 can be made by opaque material and can be a metal-fiberglass composite plate, a metal-ceramic composite plate, a printed circuit board or other types. In this embodiment, the material of the first substrate 11 and second substrate 12 is transparent glass for example. The first substrate 11 and the second substrate 12 can be attached to each other under vacuum. The first substrate 11 can include at least a TFT array and the second substrate 12 can include at least a CF array and a black matrix. However, in other embodiments, the color filter layer of the CF array or the black matrix may be disposed on the first substrate 11 for making a COA (color filter on array) substrate or a BOA (BM on array) substrate. To be noted, the above-mentioned structures are just for example but not for limiting the scope of the invention. After the step S03, a curing technique can be implemented to cure the first sealant 14 and the second sealant 15 (not shown). Herein for example, the second sealant 15 can be illuminated by UV light under atmosphere environment (not complete curing), and then the baking by oven will completely cure the first sealant 14 and the second sealant 15.

In addition, referring to FIGS. 1B, 2C and 2D, FIG. 1B is a schematic flowchart of a manufacturing method of a display panel structure of another embodiment of the invention, and FIGS. 2C and 2D are schematic diagrams showing the processes of the manufacturing method of the display panel structure of another embodiment of the invention.

In addition to the steps S01˜S03, as shown in FIG. 1B, the manufacturing method can further include the steps S04˜S06.

As shown in FIGS. 2C and 2D, the step S04 is to form a third sealant 16 to seal the edges of the first substrate 11 and second substrate 12. The third sealant 16 also can be a thermo-curing adhesive, a photo-curing adhesive or their combination. Herein for example, the third sealant 16 is a photo-curing adhesive (such as UV adhesive) and can be formed on the edges of the first substrate 11 and second substrate 12 by coating. However, this invention is not limited thereto. By the third sealant 16 connecting and sealing the edges of the first substrate 11 and the edges of the second substrate 12, the chemical agent used in the subsequent process can be prevented from damaging the inner structure of the display panel structure 1.

After the step S04 of forming the third sealant 16 and before the step S05, another curing technique can be implemented to cure the third sealant 16 (not shown). Then, the step S05 of the substrate thinning is to thin the first substrate 11 or the second substrate 12. Herein for example, the grinding, polishing or etching treatment can be used to reduce the thickness of each of the first substrate 11 and second substrate 12 as less than 0.4 mm.

Then, the step S06 is to form at least a transparent conducting layer 17 on an outer surface of the first substrate 11 or second substrate 12. Herein for example, the transparent conducting layer 17 can be formed on the outer surface of the second substrate 12 under vacuum. The material of the transparent conducting layer 17 is, for example but not limited to, indium-tin oxide (ITO), indium-zinc oxide (IZO) or other kinds of material. If the LCD units 13 of the display panel structure 1 are FFS or IPS LCD units, the transparent conducting layer 17 can act as the electrostatic protection layer of the LCD units 13 so as to enhance the electrostatic protection function of the display panel structure 1. If the LCD units 13 are touch LCD units 13 (FFS or IPS), the display panel structure 1 can be applied to the on-cell touch panel for example and the transparent conducting layer 17 can be a touch sensing layer (can include the driving electrode and sensing electrode, not shown). The transparent conducting layer 17 can be a patterned polycrystalline transparent conducting layer (the pattern is not shown in the figure), which can be formed from the transformation of an amorphous transparent conducting layer. To be noted, the method of forming the patterned polycrystalline transparent conducting layer can include the following steps of: forming at least an amorphous transparent conducting layer (material such as ITO) on the surface of the second substrate 12; patterning the amorphous transparent conducting layer by high energy pulse to make the patterned amorphous transparent conducting layer transformed into the patterned polycrystalline transparent conducting layer; and removing the non-patterned amorphous transparent conducting layer by etching. In practice, for example, the amorphous transparent conducting layer may be formed on the outer surface of the second substrate 12 by sputtering and the thickness thereof is between 200 Å and 800 Å. Then, the excimer laser annealing (ELA) treatment is implemented to the amorphous transparent conducting layer, wherein the high energy pulse directly patterns the amorphous transparent conducting layer and the amorphous transparent conducting layer is thus exposed to the high temperature in a very short time so as to be transformed into the patterned polycrystalline transparent conducting layer. Subsequently, the etching technique is used, wherein the chemical agent (such as oxalic acid) which just can etch the amorphous material is used to remove the non-patterned amorphous transparent conducting layer to obtain the patterned polycrystalline transparent conducting layer. The polycrystalline transparent conducting layer has better electrical conductivity than the amorphous transparent conducting layer. Moreover, the patterning achieved by the laser can save a step of photoresist technique, such as exposure and development. After forming the transparent conducting layer 17, a slicing technique will be further implemented (not shown) to obtain the LCD panel or touch display panel including a plurality of LCD units 13.

Through the demonstration, in the display panel structure 1 made by the manufacturing method of this embodiment, in comparison with the conventional art, the second sealant 15 is disposed on the outside of the LCD array A in a multi-segment manner, and thereby the problems of the substrate peeling and fragment occurring during the process of forming the transparent conducting layer on the outer surface of the second substrate 12 under vacuum can be improved, and besides, the internal strike effect where the liquid crystal molecules strike the sealant occurring when the first substrate 11 and the second substrate 12 are attached to each other under vacuum and the first sealant 15 is not cured can be restrained, so as to enhance the technical yield.

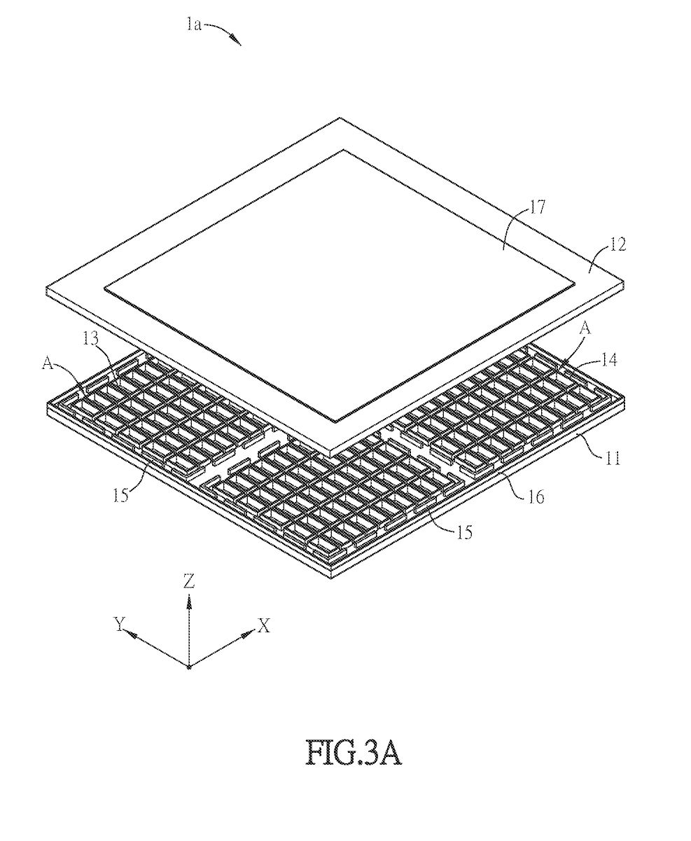

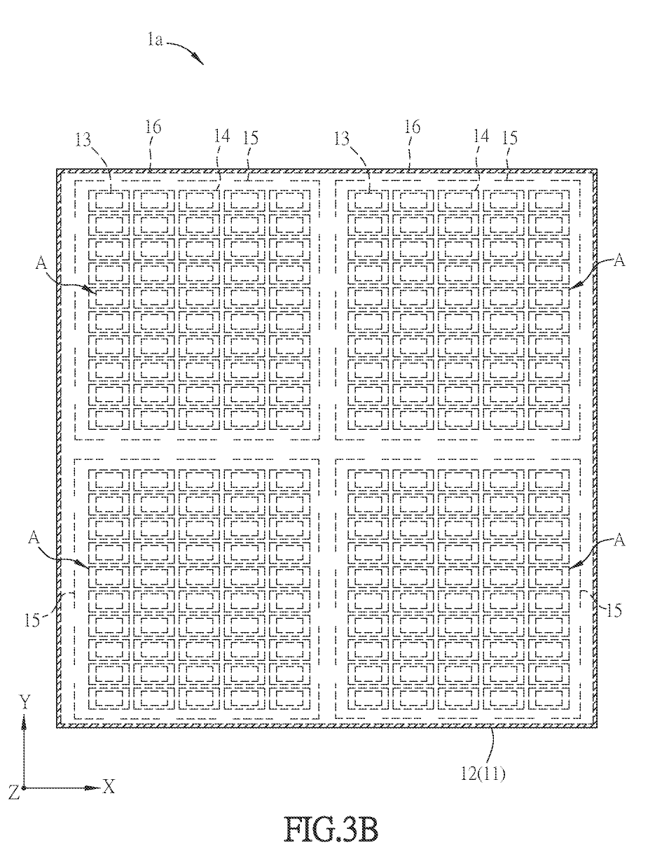

Referring to FIGS. 3A and 3B, FIGS. 3A and 3B are schematic diagrams showing the processes of the manufacturing method of the display panel structure of another embodiment of the invention.

As shown in FIGS. 3A and 3B, the manufacturing method of the display panel structure 1a is approximately the same with that of the display panel structure 1, and the main difference from the manufacturing method of the display panel structure 1 is that the first sealants 14 are disposed around the LCD units 13 on the first substrate 11 of the display panel structure 1a to form a plurality of LCD arrays A in the step S01. Herein, the LCD arrays A are arranged into a two-dimensional array. Moreover, in the step S02, a plurality of second sealants 15 are disposed on the first substrate 11, so that each of the second sealants 15 is disposed on the outside of the corresponding LCD array A in a multi-segment manner. Therefore, the display panel structure 1a includes four LCD arrays A and four second sealants 15, the LCD arrays A are arranged into a two-dimensional matrix, and each of the second sealants 15 is disposed on the outside of the LCD units 13 of the corresponding LCD array A in a multi-segment manner, so that the display panel structure 1a is a four-section board. The second sealants 15 are disposed between the LCD arrays A in a multi-segment manner and between the LCD arrays A and the edges of the first substrate 11. Moreover, the second sealants 15 are disposed separately, so that an interval region exists between two adjacent ones of the second sealants 15. In other words, the second sealants 15 are arranged into an array formed by columns (the direction Y) and rows (the direction X), and the two adjacent second sealants 15 along the column or row direction form the interval region therebetween.

In detail, these LCD arrays A are disposed separately, at least a cross-like interval region is formed between the LCD arrays A, and each of the LCD arrays A includes a plurality of LCD units 13. Moreover, these second sealants 15 connect to the first substrate 11 and the second substrate 12, and is disposed between the first substrate 11 and the second substrate 12 and also in the cross-like interval region formed by the LCD arrays A. Besides, the second sealant 15 is disposed on the outside of the LCD array A in a multi-segment manner. The second sealants 15 of this embodiment are also disposed in a two-dimensional array corresponding to the LCD arrays A. Moreover, the second sealants 15 disposed in the cross-like interval region formed by the LCD arrays A are disposed between the LCD arrays A and disposed separately to form the cross-like interval region, and the second sealants 15 are disposed on the outside of the LCD arrays A in a multi-segment manner. Herein, as shown in FIG. 3B, the second sealants 15 are disposed separately. The two adjacent second sealants 15 along the direction Y have the interval region and the two adjacent second sealants 15 along the direction X also have the interval region, so that the two interval regions form the cross-like interval region on the four-section board. Moreover, the second sealants 15 along the column direction and row direction form the cross-like interval region.

Other technical features of the display panel structure 1a can be comprehended by referring to the display panel structure 1, so the related illustration is omitted here for conciseness.

Through the demonstration, in the display panel structure 1a of this embodiment, in comparison with the conventional art, the second sealants 15 are disposed in the cross-like interval region formed by the LCD arrays A and each of the second sealants 15 is disposed on the outside of the corresponding LCD array A in a multi-segment manner, and thereby the problems of the substrate peeling and fragment occurring during the process of forming the transparent conducting layer on the outer surface of the second substrate 12 under vacuum can be improved, and besides, the internal strike effect where the liquid crystal molecules strike the sealant occurring when the first substrate 11 and the second substrate 12 are attached to each other under vacuum and the first sealant 15 is not cured can be restrained, so as to enhance the technical yield.

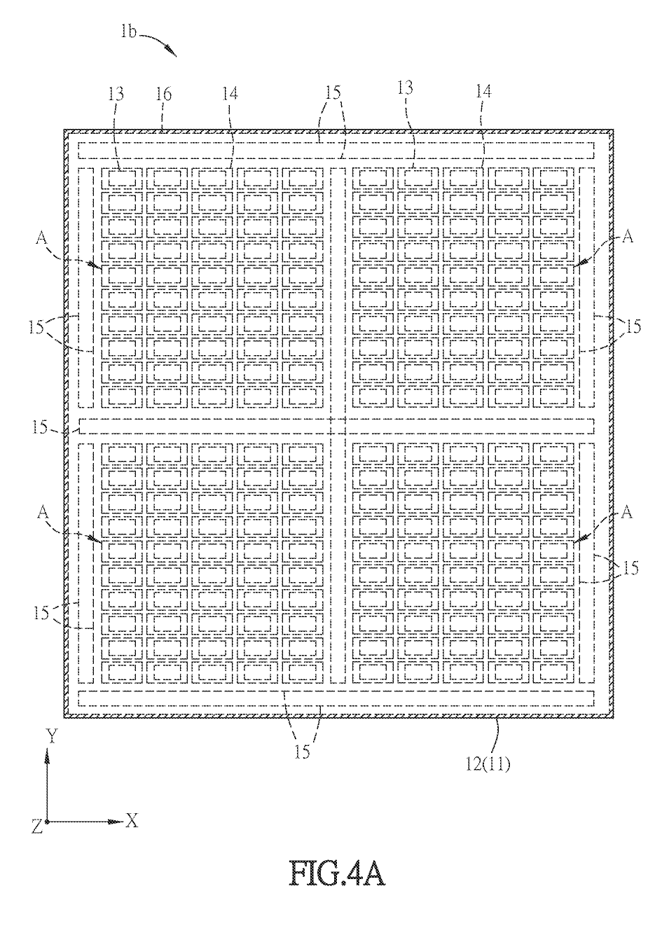

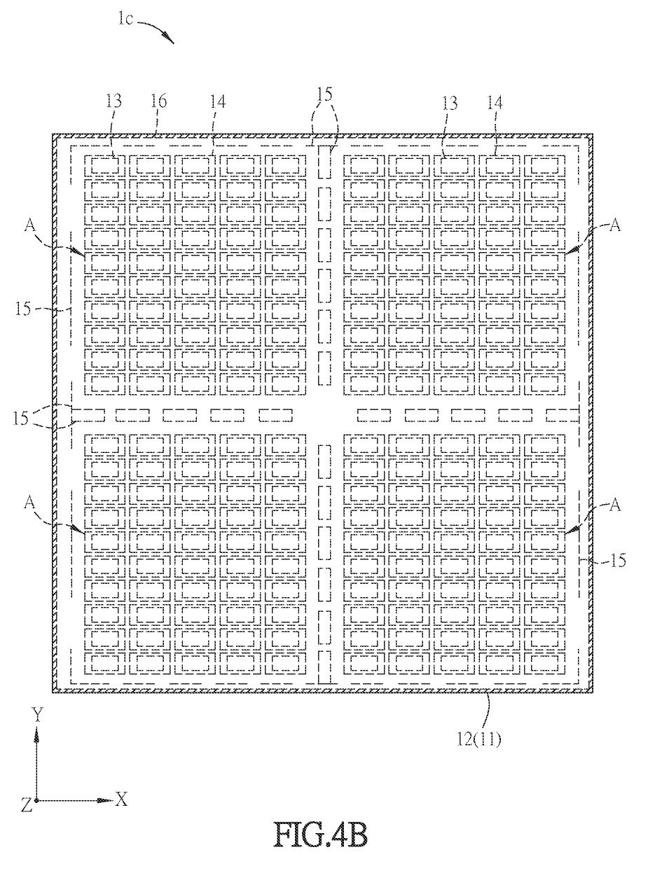

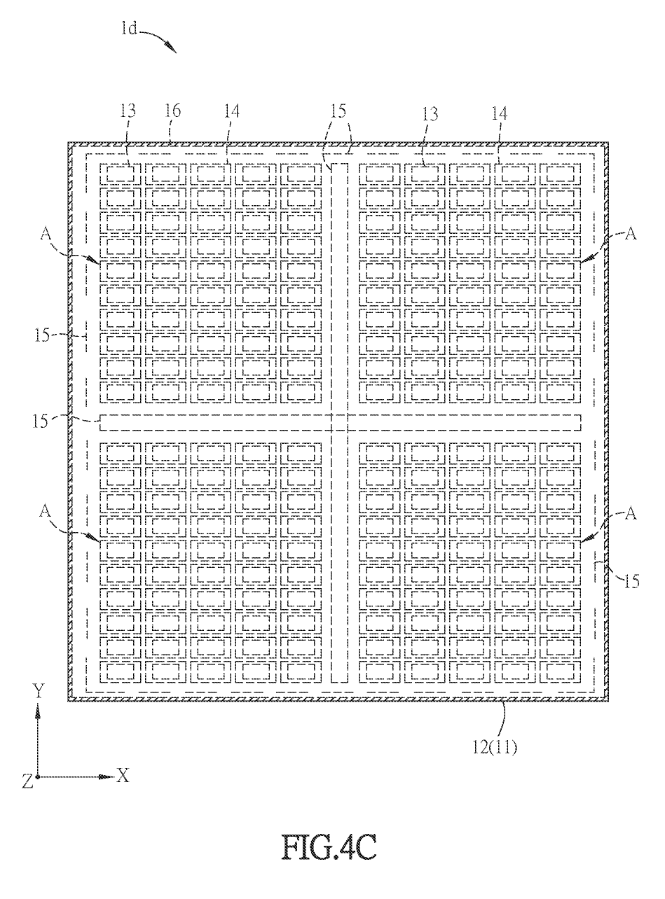

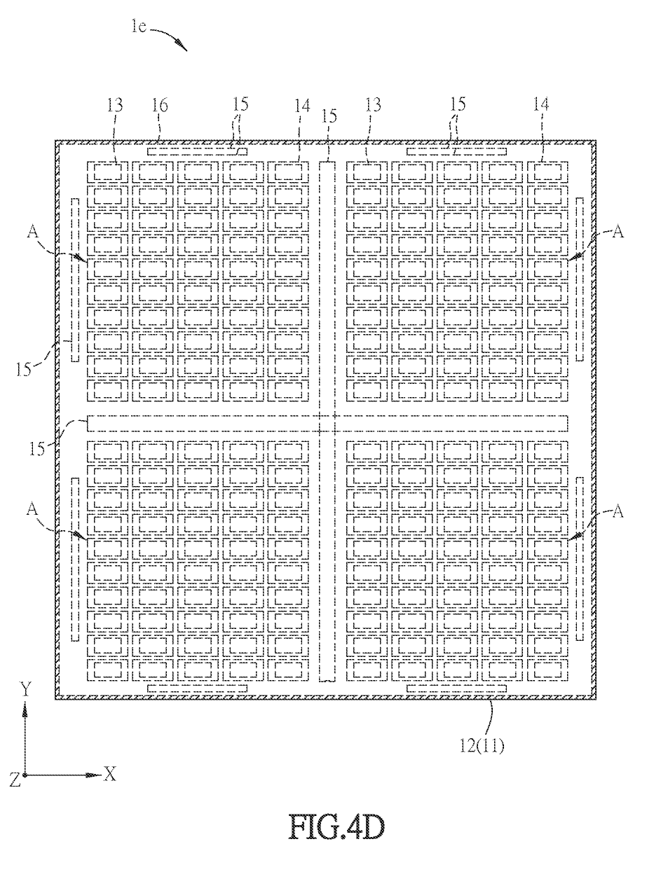

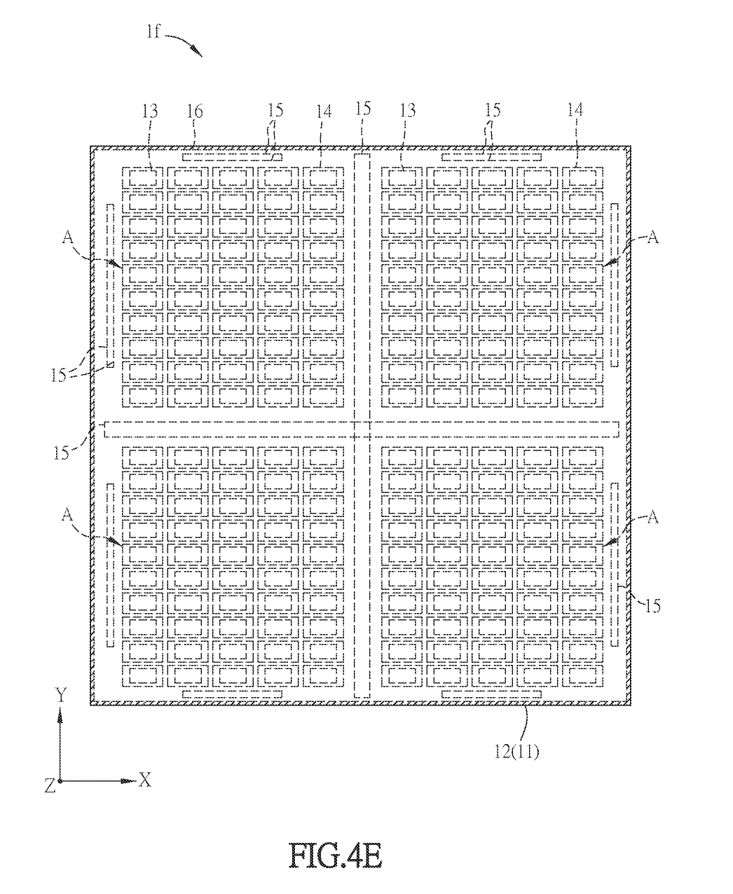

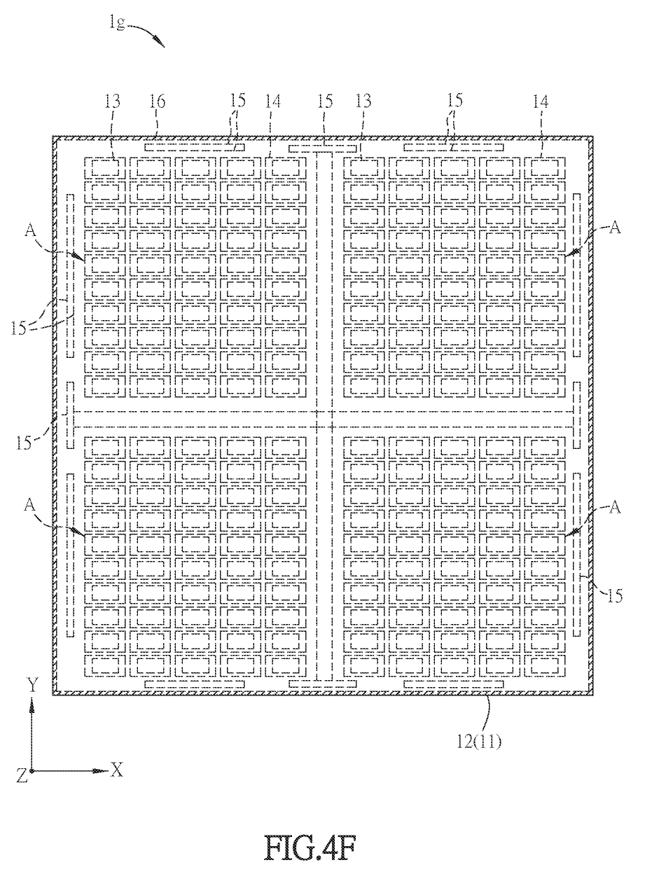

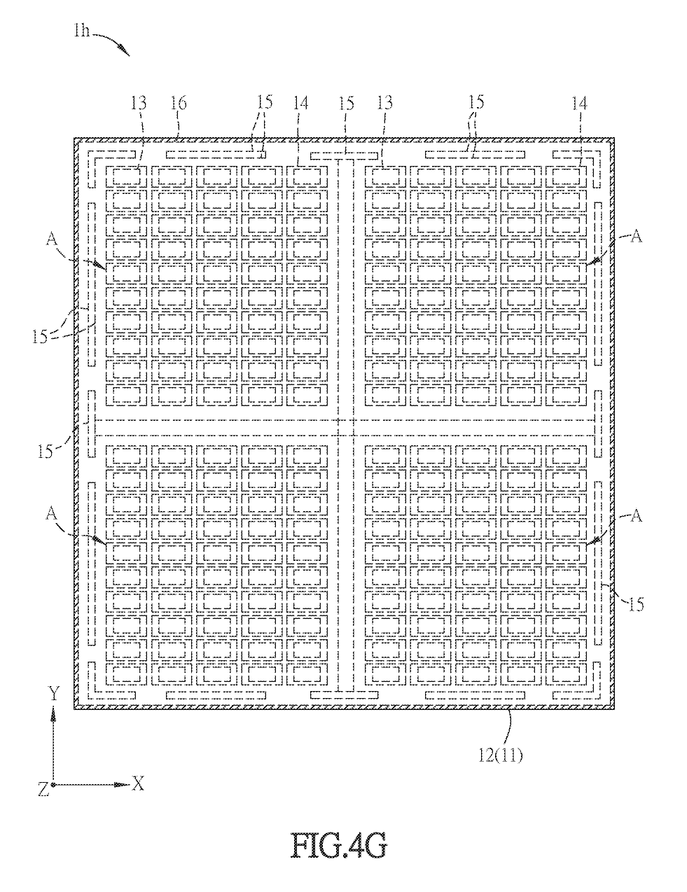

In addition, referring to FIGS. 4A to 4G, FIGS. 4A to 4G are schematic diagrams of the display panel structures 1b˜1h of different embodiments of the invention.

As shown in FIG. 4A, the main difference from the display panel structure 1a in FIG. 3B is that each of the second sealants 15 of the display panel structure 1b is disposed between the LCD arrays A and the edges of the first substrate 11 and is a double-layer structure without openings (i.e. the second sealant 15 is a continuous structure without segments). The second sealants are closed-type ones. Moreover, the adjacent closed-type second sealants 15 disposed on the upper or lower side of the first substrate 11 are connected with each other but not connected with the closed-type second sealants 15 disposed on the left or right side of the first substrate 11. Furthermore, the adjacent closed-type second sealants 15 disposed between the left or right edges of the LCD array A and first substrate 11 are not connected with each other. Besides, the second sealants 15 disposed in the cross-like interval region formed by the LCD arrays A are connected with each other and formed into a closed cross shape, and also formed into a shape like “#” in the middle portion of the four-section board, but they are not connected with the second sealants 15 which are disposed on the upper, lower, left and right sides.

Other technical features of the display panel structure 1b can be comprehended by referring to the display panel structure 1a, so the related illustration is omitted here for conciseness.

As shown in FIG. 4B, the main difference from the display panel structure 1b in FIG. 4A is that each of the second sealants 15 of the display panel structure 1c disposed between the LCD arrays A and the edges of the first substrate 11 is a single-layer and multi-segment structure. Moreover, the second sealants 15, which are disposed in the cross-like interval region defined by the LCD arrays A, are double-layer and multi-segment structures and formed into a cross shape, and are connected with the peripheral second sealants 15.

Other technical features of the display panel structure 1c can be comprehended by referring to the display panel structure 1b, so the related illustration is omitted here for conciseness.

As shown in FIG. 4C, the main difference from the display panel structure 1b in FIG. 4A is that each of the second sealants 15 of the display panel structure 1d disposed between the LCD arrays A and the edges of the first substrate 11 is a single-layer and multi-segment structure.

Other technical features of the display panel structure 1d can be comprehended by referring to the display panel structure 1b, so the related illustration is omitted here for conciseness.

As shown in FIG. 4D, the main difference from the display panel structure 1b in FIG. 4A is that each of the second sealants 15 of the display panel structure 1e disposed between the LCD arrays A and the edges of the first substrate 11 is a double-layer structure but shorter, and the adjacent second sealants 15 disposed between the upper or lower edges of the LCD arrays A and first substrate 11 are not connected to each other.

Other technical features of the display panel structure 1e can be comprehended by referring to the display panel structure 1b, so the related illustration is omitted here for conciseness.

As shown in FIG. 4E, the main difference from the display panel structure 1e in FIG. 4D is that the second sealants 15 of the display panel structure 1f, which are disposed in the cross-like interval region, are formed into a cross shape extending upwards, downwards, leftwards and rightwards to reach to between the other adjacent second sealants 15.

Other technical features of the display panel structure 1f can be comprehended by referring to the display panel structure 1e, so the related illustration is omitted here for conciseness.

As shown in FIG. 4F, the main difference from the display panel structure 1f in FIG. 4E is that the two adjacent second sealants 15 of the display panel structure 1g, which are disposed between the upper, lower, left or right edges of the LCD arrays A and first substrate 11, are divided into three segments, and the cross-like second sealants 15 extend upwards, downwards, leftwards and rightwards to connect to the second sealants 15 of the upper, lower, left and right sides, respectively.

Other technical features of the display panel structure 1g can be comprehended by referring to the display panel structure 1f, so the related illustration is omitted here for conciseness.

As shown in FIG. 4G, the main difference from the display panel structure 1g in FIG. 4F is that second sealants 15 of the display panel structure 1h disposed between the LCD arrays A and the edges of the first substrate 11 at the four corners include four double-layer structures, respectively.

Other technical features of the display panel structure 1h can be comprehended by referring to the display panel structure 1g, so the related illustration is omitted here for conciseness.

Summarily, the manufacturing method of the display panel structure of this invention includes the steps of: disposing a plurality of first sealants around a plurality of LCD units on a first substrate, respectively, to form at least an LCD array; forming at least a second sealant on the first substrate, so that the second sealant is disposed on the outside of the LCD array in a multi-segment manner; and attaching the second substrate and the first substrate to each other, so that the second sealant connects the first substrate and the second substrate. Moreover, in the display panel structure of this invention, the LCD arrays are disposed separately, at least a cross-like interval region is formed between the LCD arrays, and the second sealants are disposed in the cross-like interval region and disposed on the outside of the LCD arrays in a multi-segment manner. Thereby, in comparison with the conventional art, the problems of the substrate peeling and fragment occurring during the process of forming the transparent conducting layer for the display panel structure under vacuum can be improved, and besides, the internal strike effect of the liquid crystal occurring when the first substrate and the second substrate are attached to each other under vacuum and then return to the atmosphere environment can be restrained, so as to enhance the technical yield.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of a display panel structure, comprising steps of:
disposing a plurality of first sealants around a plurality of liquid crystal display (LCD) units on a first substrate, respectively, to form at least an LCD array;
forming at least a second sealant on the first substrate, so that the second sealant is disposed on the outside of the LCD array in a multi-segment manner; and
attaching a second substrate and the first substrate to each other, so that the second sealant connects the first substrate and the second substrate.

2. The manufacturing method as recited in claim 1, wherein in the step of forming the at least a second sealant, the second sealant is disposed between the LCD arrays.

3. The manufacturing method as recited in claim 2, wherein in the step of forming the at least a second sealant, the second sealant is disposed between the LCD array and the edges of the first substrate.

4. The manufacturing method as recited in claim 1, further comprising a step of:
forming at least a transparent conducting layer on an outer surface of the first substrate or second substrate.

5. The manufacturing method as recited in claim 4, wherein in the step of forming the at least a transparent conducting layer, the transparent conducting layer is a patterned polycrystalline transparent conducting layer, which is formed from the transformation of an amorphous transparent conducting layer.

6. The manufacturing method as recited in claim 5, in the step of forming the at least a transparent conducting layer, further comprising steps of:
forming the amorphous transparent conducting layer on a surface of the first substrate or second substrate;
patterning the amorphous transparent conducting layer by high energy pulse to make the patterned amorphous transparent conducting layer transformed into the patterned polycrystalline transparent conducting layer; and
removing the non-patterned amorphous transparent conducting layer by etching.

7. A display panel structure, comprising:
a first substrate;
a second substrate disposed corresponding to the first substrate;
a plurality of LCD arrays disposed in an array between the first substrate and the second substrate and disposed separately, wherein at least a cross-like interval region is formed between the LCD arrays, and each of the LCD arrays includes a plurality of LCD units;
a plurality of first sealants disposed around the LCD units, respectively; and
a plurality of second sealants disposed in the cross-like interval region.

8. The display panel structure as recited in claim 7, wherein each of the second sealants disposed between the LCD arrays and the edges of the first substrate is a double-layer structure and at least some of the second sealants are the closed-type ones.

9. The display panel structure as recited in claim 8, wherein the closed-type second sealant disposed on the upper or lower side of the first substrate and on the upper or lower side of the LCD arrays is not connected with the closed-type second sealant disposed on the left or right side of the first substrate, and the adjacent closed-type second sealants disposed between the LCD arrays and the left or right edges of first substrate are not connected with each other.

10. The display panel structure as recited in claim 9, wherein the closed-type second sealants disposed in the cross-like interval region are connected with each other and formed into a closed cross shape, and also formed into a shape like “#” in the middle portion.

11. The display panel structure as recited in claim 7, wherein the second sealants disposed in the cross-like interval region are connected with each other and formed into a closed cross shape, and also formed into a shape like “#” in the middle portion.

12. The display panel structure as recited in claim 7, wherein the second sealants, which are disposed in the cross-like interval region, are double-layer and multi-segment structures and formed into a cross shape.

13. The display panel structure as recited in claim 7, wherein the second sealants, which are disposed in the cross-like interval region, are double-layer and multi-segment structures and formed into a cross shape, and are connected with the second sealants disposed between the LCD arrays and edges of the first substrate.

14. The display panel structure as recited in claim 7, wherein the second sealants, which are disposed in the cross-like interval region, are double-layer and multi-segment structures and formed into a cross shape, and are not connected with the second sealants disposed between the LCD arrays and the edges of the first substrate.

15. The display panel structure as recited in claim 8, wherein the adjacent closed-type second sealants disposed between the LCD arrays and the upper or lower edges of the first substrate are not connected to each other.

16. The display panel structure as recited in claim 7, wherein the second sealants are disposed separately to form the cross-like interval region.

17. The display panel structure as recited in claim 7, wherein the second sealants disposed in the cross-like interval region are connected to each other and formed into a cross shape.

18. The display panel structure as recited in claim 17, wherein the second sealant is disposed between the LCD array and edges of the first substrate and without openings.

19. The display panel structure as recited in claim 7, wherein the second sealants disposed in the cross-like interval region are connected to each other in a multi-segment manner and formed into a cross shape.

20. The display panel structure as recited in claim 7, further comprising:
at least a transparent conducting layer disposed on an outer surface of the first substrate or second substrate.
